(19) United States
(12) Patent Application Publication
(10) Pub. No.: US 2022/0309578 A1
(43) Pub. Date: Sep. 29, 2022

(54) SYSTEM AND METHOD FOR AUTONOMOUSLY GENERATING SERVICE PROPOSAL RESPONSE

(71) Applicant: Zensar Technologies Limited, Pune (IN)

(72) Inventors: Sridhar Gadi, Pune (IN); Manish Kumar, Pune (IN); Pavan Jakati, Pune (IN); Abhishek Upadhyay, Pune (IN)

(21) Appl. No.: 17/583,844

(22) Filed: Jan. 25, 2022

(30) Foreign Application Priority Data
Mar. 23, 2021 (IN) 202121012412

(51) Int. Cl. G06Q 40/04

(52) U.S. Cl. CPC G06Q 40/04

(57) ABSTRACT

Method and system for generating a service proposal response. The method comprises receiving (301) a request for service proposal indicative of a type of service requested, collating (303) data from a plurality of repositories based on the type of service requested, extracting (305) required information from the collated data, creating (307) a discrete stack for the extracted information for the data collated from each of the plurality of repositories, processing (309) each of the discrete stack to add a context to the extracted information, filtering (311) each of the processed discrete stack by applying at least one of a Natural Language Processing (NLP) technique and deep learning technique to create a knowledge container, and dynamically generating (313), using the filtered information with the key insights, the service proposal response for the type of service requested.

### TECHNICAL FIELD

The present disclosure relates to a technique of autonomously generating service proposal response.

### BACKGROUND

A request for proposal (RFP) is a business document that announces and provides details about a project, as well as solicits bids from contractors who will help complete the project. The RFP process is considered to be a cornerstone for a big-ticket purchase by companies, government and other organizations.

Organizations engage in the RFP process, which enables buyers to compare features, functionality and price across potential vendors. A good RFP creates a clear focus on specific criteria that is important for the buyer. As a standard process, potential vendors show participation in such engagements by providing proposal response against stated requirement by buyers.

The whole process of response generation and submission goes through a rigorous set of activities which consumes lot of time and labor-intensive effort. The response also includes coordination and collaboration of multiple stakeholders across different business functions. The current framework of generating response for such requirement is manual and lacks machine intelligence. In particular, in present day scenario RFP floated by companies require bid management team of potential vendors to coordinate with multiple business units within its organization such as sales, finance, business engineering, technology experts, human resource.

Therefore, there exists a need in the art to provide a system and method which overcomes the above-mentioned problems by learning from the data and knowledge residing across various systems used by different business teams for coordinating, storing and collaborating to create the bid response or service proposal response, thereby reducing the dependency on human intervention and human intelligence.

### SUMMARY

The present disclosure overcomes one or more shortcomings of the prior art and provides additional advantages discussed throughout the present disclosure. Additional features and advantages are realized through the techniques of the present disclosure. Other embodiments and aspects of the disclosure are described in detail herein and are considered a part of the claimed disclosure.

In one non-limiting embodiment of the present disclosure, a method for generating a service proposal response is disclosed. The method comprises receiving a request for service proposal indicative of a type of service requested, collating data from a plurality of repositories based on the type of service requested, extracting required information from the collated data, and creating a discrete stack for the extracted information for the data collated from each of the plurality of repositories and each discrete stack indicates extracted information of a particular repository in sorted format. In the same embodiment of the present disclosure, the method further comprises processing each of the discrete stack to add a context to the extracted information by computing a diverse score for each information, based on the request for service proposal, filtering each of the processed discrete stack by applying at least one of a Natural Language Processing (NLP) technique and deep learning technique to create a knowledge container, the knowledge container containing filtered information with key insights, and dynamically generating, using the filtered information with the key insights, the service proposal response for the type of service requested.

In yet another non-limiting embodiment of the present disclosure, the method further comprises providing to at least one user access to the generated service proposal response and displaying the service proposal response in a readable format on a user interface.

In yet another non-limiting embodiment of the present disclosure, the processing of each of the discrete stack for adding the context to the extracted information comprises computing the diverse score for each information present in the discrete stack, the diverse score being computed based on a set of parameters including information in discrete stack, a total number of same information in the discrete stack of the repository, and a total number of same information in the discrete stack of other repositories, and rearranging each of the information in the discrete stack based on the diverse score.

In yet another non-limiting embodiment of the present disclosure, the filtering of each of the processed discrete stack comprises masking sensitive information from each of the processed discrete stack of extracted information, applying the at least one of the NLP technique and the deep learning technique to generate key insights for unmasked information present in the processed discrete stack, and storing the unmasked information present in the stack along with the respective key insights in the knowledge container. The key insight comprises tuned diverse score for each unmasked information present in the discrete stack.

In yet another non-limiting embodiment of the present disclosure, the at least one NLP technique and deep learning technique comprises Bidirectional Encoder Representations from Transformers (BERT) and Tesseract 4.

In yet another non-limiting embodiment of the present disclosure, a system for generating a service proposal response is disclosed. The system comprises a memory and a user interface in communication with the memory. The user interface is configured to receive a request for service proposal indicative of a type of service requested. The system further comprises at least one processor in communication with the memory and the user interface. In the same embodiment of the present disclosure, the system also comprises a document interface computational task (DICT) unit in communication with the at least one processor. The DICT unit is configured to collate data from a plurality of repositories based on the type of service requested, extract required information from the collated data, and create a discrete stack for the extracted information for the data collated from each of the plurality of repositories, each discrete stack being indicative of extracted information of a particular repository in sorted format. The system further comprises an information context analyzer (ICA) unit in communication with the DICT unit and the at least one processor. The ICA unit is configured to process each of the discrete stack to add a context to the extracted information by computing a diverse score for each information, based on the request for service proposal. The system comprises Bid Knowledge Response System (BKRS) unit in communication with the ICA unit and the at least one processor, and configured to filter each of the processed discrete stack by applying at least one of a natural language processing (NLP) technique and deep learning technique to create a knowledge container. The knowledge container contains filtered information with key insights. The system comprises a bid generator unit in communication with the BKRS unit and the at least one processor. The bid generator unit is configured to dynamically generate, using the filtered information with the key insights, the service proposal response for the type of service requested.

In yet another non-limiting embodiment of the present disclosure, the at least one processor is configured to provide to at least one user access to the generated service proposal response and the user interface is configured to display the service proposal response to the at least one user.

In yet another non-limiting embodiment of the present disclosure, to process each of the discrete stack to add the context to the extracted information, the ICA unit is configured to compute the diverse score for each information present in the discrete stack, the diverse score being computed based on a set of parameters including information in discrete stack, a total number of same information in the discrete stack of the repository, and a total number of same information in the discrete stack of other repositories, and rearrange each of the information in the discrete stack based on the diverse score.

In yet another non-limiting embodiment of the present disclosure, to filter each of the processed discrete stack, the BKRS unit is configured to mask sensitive information from each of the processed discrete stack of extracted information, apply the at least one of the NLP technique and the deep learning technique to generate key insights for unmasked information present in the stack, and store the unmasked information present in the stack along with the respective key insights in the knowledge container. The key insight comprises tuned diverse score for each unmasked information present in the discrete stack.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The features, nature, and advantages of the present disclosure will become more apparent from the detailed description set forth below when taken in conjunction with the drawings in which like reference characters identify correspondingly throughout. Some embodiments of system and/or methods in accordance with embodiments of the present subject matter are now described, by way of example only, and with reference to the accompanying figures, in which:

FIG. 1 shows an exemplary framework for Document Discovery Analysis and Processing (DDAP), in accordance with an embodiment of the present disclosure;

FIG. 2 illustrates data integration and data flow in a DDAP framework, in accordance with an embodiment of the present disclosure;

FIG. 3 shows a flow chart illustrating an exemplary method for generating a service proposal response, in accordance with an embodiment of the present disclosure;

FIG. 4(a) shows a block diagram illustrating a system for generating a service proposal response, in accordance with an embodiment of the present disclosure;

FIG. 4(b) show a block diagram illustrating a Bid Knowledge Response System (BKRS) unit, in accordance with an embodiment of the present disclosure;

FIG. 5(a) illustrates a system data flow architecture of DDAP, in accordance with an embodiment of the present disclosure;

FIG. 5(b) illustrates a functional architecture of DDAP, in accordance with an embodiment of the present disclosure;

FIG. 6 illustrates an embedding generation using Bidirectional Encoder Representations from Transformers (BERT), in accordance with an embodiment of the present disclosure;

FIG. 7 (a) illustrates a workflow for extracting text from an image using Tesseract 4, in accordance with an embodiment of the present disclosure;

FIG. 7 (b) shows an exemplary neural network layers for generating a service proposal response, in accordance with an embodiment of the present disclosure;

FIG. 7(c) illustrates long-short term memory (LSTM) layers, in accordance with an embodiment of the present disclosure;

FIG. 7(d) illustrates an exemplary long-short term memory (LSTM) approach, in accordance with an embodiment of the present disclosure;

It should be appreciated by those skilled in the art that any block diagram herein represents conceptual views of illustrative systems embodying the principles of the present subject matter. Similarly, it will be appreciated that any flow charts, flow diagrams and the like represent various processes which may be substantially represented in computer readable medium and executed by a computer or processor, whether or not such computer or processor is explicitly shown.

### DETAILED DESCRIPTION

The terms “comprise”, “comprising”, “include(s)”, or any other variations thereof, are intended to cover a non-exclusive inclusion, such that a setup, system or method that comprises a list of components or steps does not include only those components or steps but may include other components or steps not expressly listed or inherent to such setup or system or method. In other words, one or more elements in a system or apparatus proceeded by “comprises . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

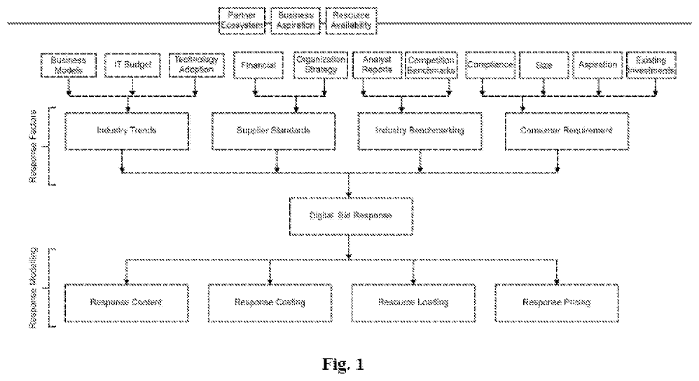

FIG. 1 shows an exemplary framework for Document Discovery Analysis and Processing (DDAP), in accordance with an embodiment of the present disclosure.

In one embodiment of the present disclosure, the Document Discovery Analysis and Processing (DDAP) operates by collecting documents from various sources in any organization. The documents collected are then analyzed for details and post analysis the bid responses are generated. A bid response system generating the bid responses may contain details in the form of RFI/RFQ/RFP which may be shared with the business for new bids or bid renewal. When a bid response has to be created for any upcoming bids, the bid related details may be fed into the bid response system. The bid response system then looks into every details of the bids and then creates a final response by analyzing the bid containers and finally proposing the response in the form of BID RFP/RFI/RFQ to the user.

In one embodiment of the present disclosure, the framework for DDAP may comprise response factors and response modelling. The response factors may include industry trends, supplier standards, industry benchmarking, consumer requirements. The response factors may vary from industry to industry at certain point of time. The response factors may be determined at least based on the business models, IT budgets, technology adaptation, financial activities, organization strategy, analyst reports, competition benchmarks, compliance requirement, size requirement, aspiration of the consumer and existing investments.

In one embodiment of the present disclosure, the response modelling may comprise modelling of response content, response costing, resource loading, and response costing. The modeled values of response content, response costing, resource loading, and response costing may be used for generating a digital bid response or a service proposal response. However, the response factors and response modelling parameters are not limited to above examples and any other factor or parameter required for generating the service proposal response is well within the scope of the present disclosure.

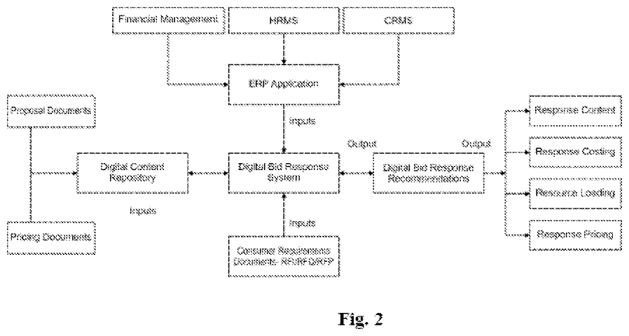

FIG. 2 illustrates data integration and data flow in a DDAP framework, in accordance with an embodiment of the present disclosure.

In one embodiment of the present disclosure, data from various system such as financial management system, human resource management system (HRMS), and customer relationship management system (CRMS) may be fed to a digital bid response system through an ERP application. The financial management system may provide data on assets, income, and expenses and may deliver accurate financial information across the organization. The HRMS may provide a means of acquiring, storing, analyzing and distributing information to various stakeholders. The CRMS may compile data from a range of different communication channels, including a company's website, telephone, email, live chat, marketing materials and more recently, social media. CRMS data may help in identifying target audiences and how to best cater for their needs, thus retaining customers and driving sales growth.

In one embodiment of the present disclosure, various proposal and pricing documents previously stored in digital content repository are retrieved and are fed to the digital bid response system. The digital bid response system further receives customer requirement documents in the form of request for information (RFI), request for quotation (RFQ), and request for proposal (RFP). The RFI/RFP/RFQ may be directly received from a customer or any other external source.

In one embodiment of the present disclosure, the digital bid response system may extract insightful facts and figures from the input documents and process the details for analysis using machine learning techniques. In an exemplary embodiment, BERT based NLP techniques and Deep Learning techniques (Tesseract) may be used for document analysis, which extracts information available in widgets present in the document and builds model. The extracted information may be processed to form organized details that are stored in a bid or knowledge containers.

In one embodiment of the present disclosure, the digital bid response system may then generate digital bid response recommendation based on the information stored in the knowledge container and the customer requirement mentioned in the RFI/RFP/RFQ. The digital bid response recommendation may at least comprise response content, response costing, response loading, and response pricing. The digital bid response may be presented to a user in a readable format on a user interface. In another embodiment of the present disclosure, the digital bid response may be provided to a system administrator for quality check.

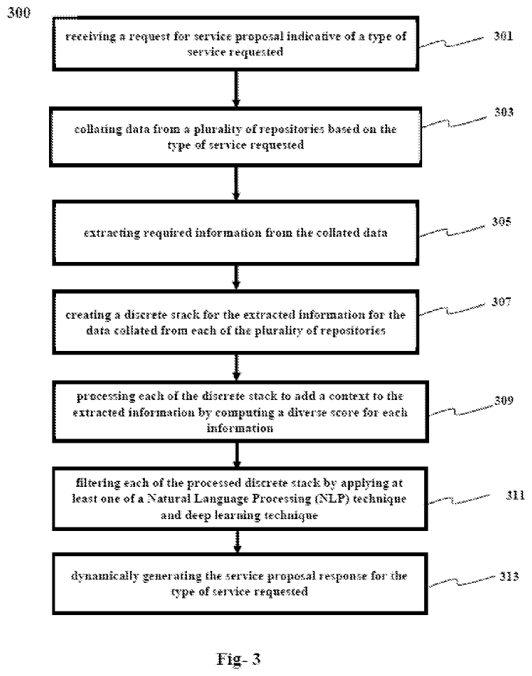

FIG. 3 shows a flow chart illustrating an exemplary method 300 for generating a service proposal response, in accordance with an embodiment of the present disclosure.

At block 301, the method 300 discloses receiving a request for service proposal indicative of a type of service requested. The request may comprise customer requirement documents in the form of request for information (RFI), request for quotation (RFQ), and request for proposal (RFP). The RFI/RFP/RFQ may specify the business goals for the project and identifying specific requirements or exact specifications required by the company.

At block 303, the method 300 discloses collating data from a plurality of repositories or sources, based on the type of service requested. The collation of data may be performed in a Document Interface for Computational Task (DICT) layer (layer 1). The plurality of repositories may comprise various proposal documents of different business units related to a specific proposal request. Each business unit may create a different proposal documents for different types of service proposal request and store such proposal documents in their respective repository or database. The terms “repository” and “source” are used alternatively in the present disclosure and have the same meaning throughout the present disclosure.

At block 305, the method 300 discloses extracting required information from the collated data. The extraction may be performed in the DICT layer. The required information is extracted by applying technique such as parsing to the collated data. However, the extraction technique is not limited to above example and any technique known to a person skilled in the art is well within the scope of the present disclosure.

At block 307, the method 300 discloses creating a discrete stack for the extracted information for the data collated from each of the plurality of repositories. The discrete stack may be termed as DICT stack or DICT(S(x)). Each of the discrete stack indicates extracted information of a particular repository in sorted format. The sorted format can be listing the information present in the documents i.e. info 1, info 2, info 3, . . . info N. The number of documents being processed at the DICT layer may determine the number of unique stacks to be created. The output from the DICT layer may act as an input for the Information Context Analyzer (ICA) layer (layer 2).

At block 309, the method 300 discloses processing each of the discrete stack for adding a context to the extracted information, based on the request received for service proposal. The processing of the discrete stack may take place in ICA layer. The processing of each of the discrete stack may comprise computing a diverse score for each information present in the discrete stack and rearranging each of the information in the discrete stack based on the computed diverse score. It is to be appreciated that the diverse score is computed based on a set of parameters including information in discrete stack, a total number of same information in the discrete stack of the repository, and a total number of same information in the discrete stack of other repositories.

In a specific embodiment, the ICA layer adds context to the information in the DICT(S(x)) and then arranges them accordingly based on the context understanding. The context understanding happens based on the information captured from ICA layer. The output of the ICA layer may be a better contextualized information stack. The output from the ICA layer may form the input for the BKRS layer.

In one non-limiting embodiment of the present disclosure, the diverse score for each information present in the discrete stack may be calculated as follows:

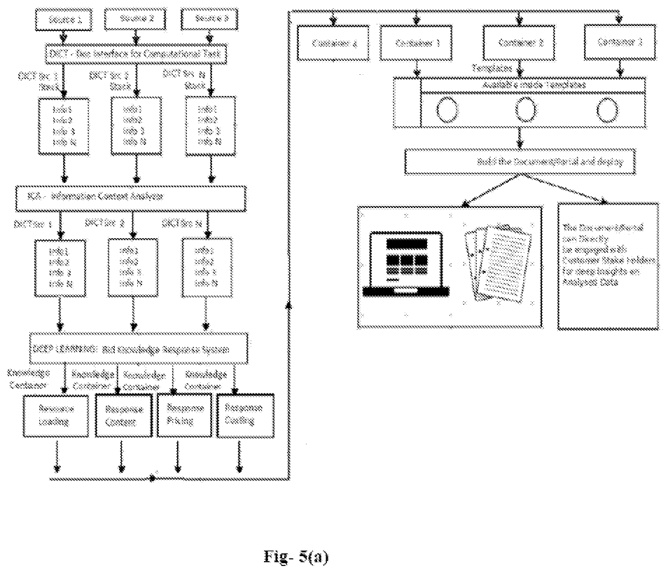

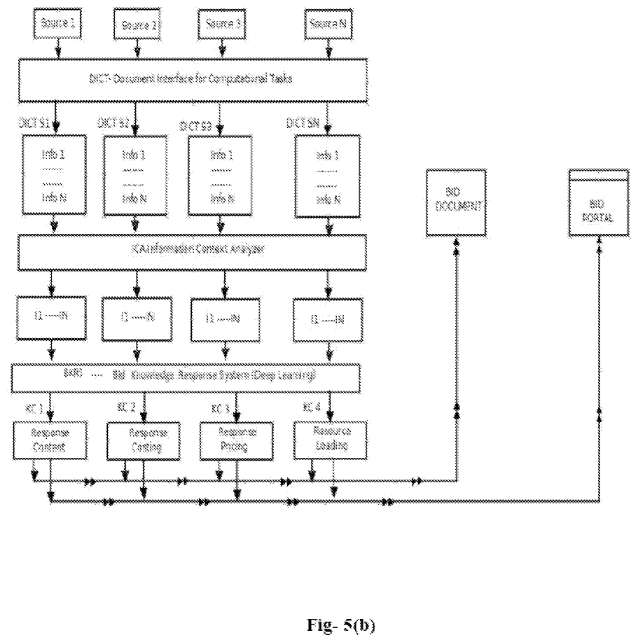

The DICT stacks created in DICT layer may have information in the form of documents, as shown in FIG. 5(a) later. The ICA layer shall transform the DICT(s) based on the information diversity present in it. Firstly, in the ICA layer, the number of document/Info blocks may be calculated based on the information present in the DICT(s).

TABLE 1

| | Source 1 | Source 2 | Source 3 | Source 4 | Total(N″) |
|---|---|---|---|---|---|
| Info 1 | 4 | 12 | 12 | 12 | 40 |
| Info 2 | 2 | 22 | 10 | 16 | 50 |
| Info 3 | 5 | 4 | 8 | 10 | 27 |
| Info 4 | 5 | 8 | 4 | 24 | 41 |
| Total(N′) | 16 | 46 | 34 | 62 | |

Then, the diverse score of the (info 1/2/3/4) information present in the respective DICT(s) may be calculated as shown in table 2 below using the following formula:

D′=−lim(i->1 to n)[(ni/N′*nᵢ/N″)ln((nᵢ/N′*i/N″)] (A)

nᵢ=info in the DICT(s) (B)

N′=Total same info's in the DICT(s) in same source (C)

N″=Total same info's in the DICT(s) in other sources (D)

TABLE 2

| | Source 1 | Source 2 | Source 3 | Source 4 |
|---|---|---|---|---|
| Info 1 | −(4/16 * 4/40) | −(12/16 * 12/40) | −(12/16 * 12/40) | −(12/16 * 12/40) |
| | ln(4/16 * 4/40) = 0.092 | ln(12/16 * 12/40) = 0.335 | ln(12/16 * 12/40) = 0.335 | ln(12/16 * 12/40) = 0.335 |
| Info 2 | −(2/16 * 2/50) | −(22/16 * 22/50) | −(10/16 * 10/50) | −(16/16 * 16/50) |
| | ln(2/16 * 2/50) = 0.026 | ln(22/16 * 22/50) = 0.303 | ln(10/16 * 10/50) = 0.258 | ln(16/16 * 16/50) = 0.364 |
| Info 3 | −(5/16 * 5/27) | −(4/16 * 4/27) | −(8/16 * 8/27) | −(10/16 * 10/27) |
| | ln(5/16 * 5/27) = 0.163 | ln(4/16 * 4/27) = 0.121 | ln(8/16 * 8/27) = 0.282 | ln(10/16 * 10/27) = 0.338 |
| Info 4 | −(5/16 * 5/41) | −(8/16 * 8/41) | −(4/16 * 4/41) | −(24/16 * 24/41) |
| | ln(5/16 * 5/41) = 0.124 | ln(8/16 * 8/41) = 0.226 | ln(4/16 * 4/41) = 0.089 | ln(24/16 * 24/41) = 0.114 |

The result of the diverse score calculation is shown in table 3 below:

TABLE 3

| | Source | Source | Source | Source |
|---|---|---|---|---|
| | 1(score) | 2(score) | 3(score) | 4(score) |
| Info 1(D′) | 0.092 | 0.335 | 0.335 | 0.335 |
| Info 2(D′) | 0.026 | 0.303 | 0.258 | 0.364 |
| Info 3(D′) | 0.163 | 0.121 | 0.282 | 0.338 |
| Info 4(D′) | 0.124 | 0.226 | 0.089 | 0.114 |

The ICA layer may then look for maximum score for any relevant information based on context across all the DICT(s). The ICA layer may then move the information block to DICT(s) with maximum score. If more than one DICT(s) have the same score for the document, then the information block will be moved to first available DICT as shown in table 4 below:

TABLE 4

| | Source | Source | Source | Source |
|---|---|---|---|---|
| | 1(score) | 2(score) | 3(score) | 4(score) |
| Info 1(D′) | | 0.335 + 0.335 + | | |
| | | 0.335 + 0.092 = | | |
| | | 1.097 | | |
| Info 2(D′) | | | | 0.364 + 0.026 + |
| | | | | 0.258 + 0.303 = |
| | | | | 0.951 |
| Info 3(D′) | | | | 0.338 + 0.282 + |
| | | | | 0.163 + 0.121 = |
| | | | | 0.904 |
| Info 4(D′) | | 0.226 + 0.124 + | | |
| | | 0.089 + 0.114 = | | |
| | | 0.553 | | |
| TOTAL | 0 | 1.65 | 0 | 1.855 |

The ICA layer may then generate a diverse percentile score for the information block with respect to all the information in the DICT as shown in Table 5 below:

TABLE 5

| | Mean Average | Mean Average | Mean Average | Mean Average |
|---|---|---|---|---|
| | Score -Source | Score - Source | Score -Source | Score -Source |
| | 1(score) | 2(score) | 3(score) | 4(score) |
| Info 1(D′) | | 1.097/1.65 = 66% | | |
| Info 1(D′) | | | | 0.951/1.855 = 51% |
| Info 1(D′) | | | | 0.904/1.855 = 48.7% |
| Info 1(D′) | | 0.553/1.65 = 33.5% | | |
| TOTAL | 0 | 1.65 | 0 | 1.855 |

At block 311, the method 300 discloses filtering each of the processed discrete stack by applying at least one of a Natural Language Processing (NLP) technique and deep learning technique to create a knowledge container. The knowledge container contains filtered information with key insights. The filtering of each of the processed discrete stack may take place in Bid Knowledge Response System (BKRS) layer (layer 3). In one non-limiting embodiment, the filtering of stack by applying at least one of a Natural Language Processing (NLP) technique and deep learning technique may be stored in one or more knowledge containers.

In one embodiment of the present disclosure, the filtering of each of the processed discrete stack may comprise masking sensitive information from each of the processed discrete stack of extracted information, applying the at least one of the NLP technique and the deep learning technique to generate key insights for unmasked information present in the processed discrete stack, and storing the unmasked information present in the stack along with the respective key insights in the one or more knowledge containers. The key insights comprise tuned diverse score for each unmasked information present in the discrete stack. In one non-limiting embodiment of the present disclosure, masking sensitive information may be performed using Bidirectional Encoder Representations from Transformers (BERT).

In one embodiment of the present disclosure, the NLP technique and the deep learning technique may be used to tune the values of the diverse score as new documents are introduced or stored in plurality of repositories. Thus, with increasing number of documents the method may compute the diverse score in a manner discussed above and keeps tuning the diverse score based on information blocks available in the newly stored documents. The tuned diverse score for each unmasked information present in the discrete stack is stored as key insights in the respective knowledge container.

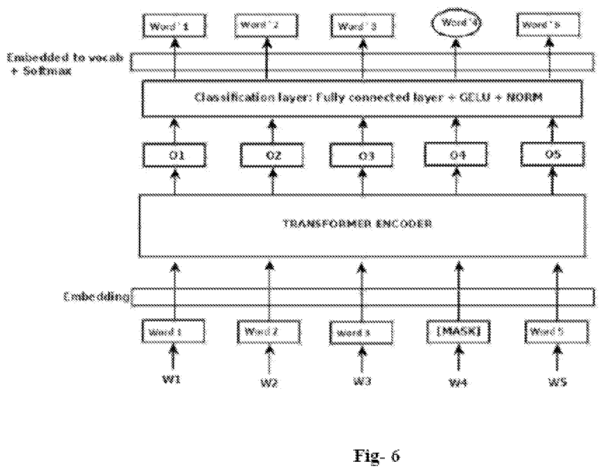

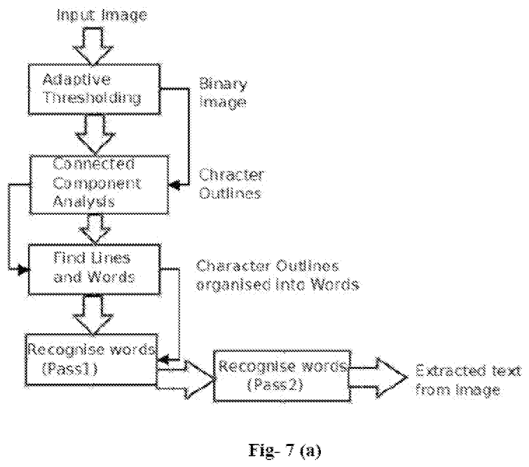

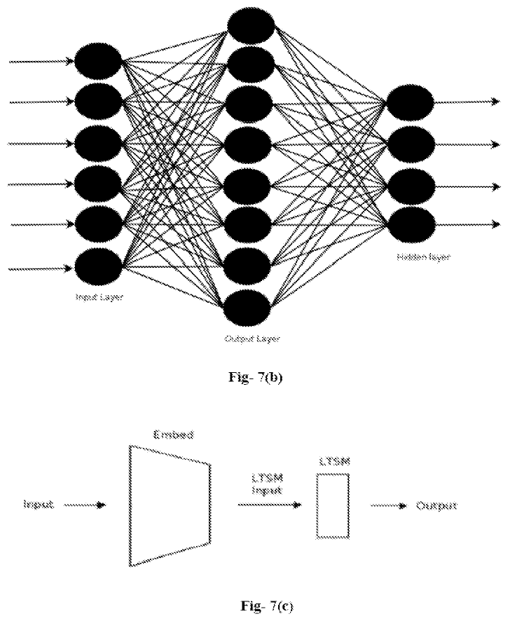

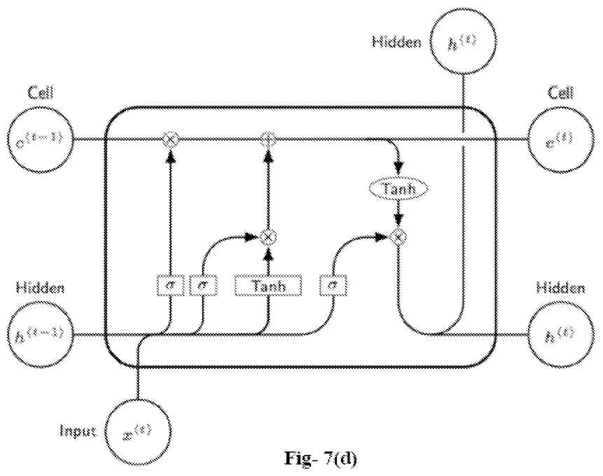

In one embodiment of the present disclosure, applying the at least one of the NLP technique and the deep learning technique comprises applying BERT and Tesseract 4. The BERT may be used for extracting information from the text documents as shown in FIG. 6 and Tesseract 4 may be used for extracting text from images as shown in FIG. 7(a). However, the application of the NLP technique and the deep learning technique is not limited to above exemplary embodiment and any other NLP technique and the deep learning technique is well within the scope of the present disclosure.

In one embodiment of the present disclosure, the NLP technique and the deep learning technique may be used to tune the diverse score values calculated previously in the processing step as discussed above. The tuning of diverse score values using the NLP technique and the deep learning technique facilitates better contextualization of the information in the processed discrete stack. The storing the unmasked information present in the stack along with the respective key insights in the knowledge container may comprise storing the unmasked information present in the stack with the tuned diverse score in the one or more knowledge containers.

In one embodiment of the present disclosure, the result of the BKRS layer may form four knowledge containers. The knowledge containers are available to the next layer and may comprise response content, response costing, response pricing, resource loading. The data in the knowledge containers may act an input to a bid generator layer (layer 4).

At block 313, the method 300 discloses dynamically generating, using the filtered information with the key insights, the service proposal response for the type of service requested. The service proposal response or final bid responses may be generated in the bid generator layer using the knowledge containers. The final bid responses may be represented as RFI/RFQ/RFP. The service proposal response can be generated as a document and deployed on a document portal for the business to access. Thus, the system learns from the data and knowledge residing across various systems used by different business teams for coordinating, storing and collaborating to create the service proposal response, thereby reducing the dependency on human intervention and human intelligence.

In one embodiment of the present disclosure, the method 300 further discloses providing to at least one user access to the generated service proposal response and displaying the service proposal response in a readable format on a user interface. In another embodiment of the present disclosure, the steps of method 300 may be performed in an order different from the order described above.

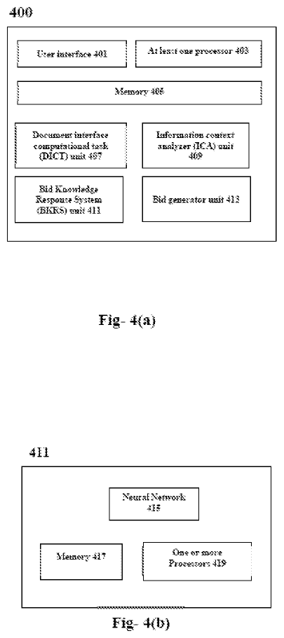

FIG. 4(a) shows a block diagram illustrating a system 400 for generating a service proposal response and FIG. 4(b) show a block diagram illustrating a Bid Knowledge Response System (BKRS) unit 411, in accordance with an embodiment of the present disclosure.

In an embodiment of the present disclosure, a system 400 may comprise a user interface 401, at least one processor 403, memory 405, Document interface computational task (DICT) unit 407, Information context analyzer (ICA) unit 409, Bid Knowledge Response System (BKRS) unit 411, and Bid generator unit 413 in communication with each other.

The user interface 401 may be configured to receive a request for service proposal indicative of a type of service requested. The request may comprise customer requirement documents in the form of request for information (RFI), request for quotation (RFQ), and request for proposal (RFP). The RFI/RFP/RFQ may specify the business goals for the project and identifying specific requirements or exact specifications required by the company.

The DICT 407 unit may be configured to collate data from a plurality of repositories or sources, based on the type of service requested. The plurality of repositories or sources may be present within the memory 405. The plurality of repositories may comprise various proposal documents of different business units related to a specific proposal request. Each business unit may create a different proposal documents for different types of service proposal request and store such proposal documents in their respective repository or database.

The DICT 407 unit may be then configured to extract required information from the collated data. The extraction may be performed in the DICT layer. The required information is extracted by application of technique such as parsing to the collated data. However, the extraction technique is not limited to above example and any technique known to a person skilled in the art is well within the scope of the present disclosure.

The DICT 407 unit may be then configured to create a discrete stack for the extracted information for the data collated from each of the plurality of repositories. The discrete stack may be termed as DICT stack or DICT(S(x)). Each of the discrete stack indicates extracted information of a particular repository in sorted format. The sorted format can be listing the information present in the documents i.e. info 1, info 2, info 3, . . . info N. The number of documents being processed at the DICT layer may determine the number of unique stacks to be created. The output from the DICT unit 407 may act as an input for the ICA unit 409.

The ICA unit 409 may be configured to process each of the discrete stack to add a context to the extracted information, based on the request received for service proposal. For processing each of the discrete stack the ICA unit 409 may be configured to compute a diverse score for each information present in the discrete stack and rearrange each of the information in the discrete stack based on the diverse score. The diverse score may be computed based on a set of parameters including information in discrete stack, a total number of same information in the discrete stack of the repository, and a total number of same information in the discrete stack of other repositories.

The ICA unit 409 adds context to the information in the DICT(S(x)) and then arranges them accordingly based on the context understanding. The output of the ICA unit 409 indicates better contextualized information stack. The output from the ICA unit 409 may form the input for the BKRS unit 411.

In one non-limiting embodiment of the present disclosure, the diverse score for each information present in the discrete stack may be calculated as discussed above.

The BKRS unit 411 may comprise a neural network 415, a memory 417, and one or more processors 419. The BKRS unit 411 may be configured to filter each of the processed discrete stack by applying at least one of a Natural Language Processing (NLP) technique and deep learning technique to create a knowledge container. The knowledge container contains filtered information with key insights. In one non-limiting embodiment, the filtering of stack by applying at least one of a Natural Language Processing (NLP) technique and deep learning technique may be stored in one or more knowledge containers.

In one embodiment of the present disclosure, for filtering of each of the processed discrete stack the BKRS unit 411 may be configured to mask sensitive information from each of the processed discrete stack of extracted information, apply the at least one of the NLP technique and the deep learning technique to generate key insights for unmasked information present in the processed discrete stack, and store the unmasked information present in the stack along with the respective key insights in the one or more knowledge containers of the memory 405. The tuned diverse score for each unmasked information present in the discrete stack is stored as key insights in the respective knowledge container. In one non-limiting embodiment of the present disclosure, the neural network 415 may mask sensitive information using Bidirectional Encoder Representations from Transformers (BERT).

In one embodiment of the present disclosure, the BKRS unit 411 may apply the NLP technique and the deep learning technique to tune the values of the diverse score as new documents are introduced or stored in plurality of repositories. Thus, with increasing number of documents the BKRS unit 411 may compute the diverse score in a manner discussed above and may tune the diverse score based on information blocks available in the newly stored documents. The tuned diverse score for each unmasked information present in the discrete stack is stored as key insights in the respective knowledge container.

In one embodiment of the present disclosure, the neural network 415 may apply BERT and Tesseract 4. The BERT may be used for extracting information from the text documents as shown in FIG. 6 and Tesseract 4 may be used for extracting text from images as shown in FIG. 7(a). However, the application of the NLP technique and the deep learning technique is not limited to above exemplary embodiment and any other NLP technique and the deep learning technique is well within the scope of the present disclosure.

In one embodiment of the present disclosure, the NLP technique and the deep learning technique may be used to tune the diverse score values calculated previously in the processing step as discussed above. The tuning of diverse score values using the NLP technique and the deep learning technique facilitates better contextualization of the information in the processed discrete stack. The storing the unmasked information present in the stack along with the respective key insights in the knowledge container may comprise storing the unmasked information present in the stack with the tuned diverse score in the one or more knowledge containers.

In one embodiment of the present disclosure, the BKRS unit may store the unmasked information present in the stack along with the respective key insights inside four knowledge containers of memory 405. The knowledge containers are available to bid generator unit 413 and may comprise response content, response costing, response pricing, resource loading.

The bid generator unit 413 may be configured to dynamically generate, using the filtered information with the key insights, the service proposal response for the type of service requested. The service proposal response or final bid response may be represented as RFI/RFQ/RFP. The service proposal response can be generated as a document and deployed on a document portal for the business to access.

The DICT unit 407, ICA unit 409, and bid generator unit 413 may comprise one or more processor and memory. In one non-limiting embodiment of the present disclosure, DICT unit 407, ICA unit 409, and bid generator unit 413 may comprise a specific hardware circuitry to perform the functions as discussed above.

In one embodiment of the present disclosure, the at least one processor 403 is configured to provide to at least one user access to the generated service proposal response and the user interface is configured to display the service proposal response to the at least one user. Thus, the system 400 learns from the data and knowledge residing across various systems used by different business teams for coordinating, storing and collaborating to create the service proposal response, thereby reducing the dependency on human intervention and human intelligence.

FIG. 5(a) illustrates a system data flow architecture of DDAP and FIG. 5(b) illustrates a functional architecture of DDAP, in accordance with an embodiment of the present disclosure.

In an exemplary embodiment of the present disclosure, in response to receiving a request for service proposal, data from a plurality of repositories (such as source 1, source 2, source 3, . . . source N) are collated, using a DICT, based on a type of service requested. The DICT then extracts required information from the collated data and creates a discrete stack (DICT Src 1, DICT Src 2, . . . DICT Src N) of the extracted information for the data collated from each of the plurality of repositories (source 1, source 2, source 3, . . . source N). Each discrete stack indicates extracted information of a particular repository in sorted format (info 1, info 2, . . . info N). The discrete stacks (DICT Src 1, DICT Src 2, . . . DICT Src N) are processed, by the ICA, for adding a context to the extracted information based on the request for service proposal. The ICA shall compute a diverse score for each information present in the discrete stack and rearrange each of the information in the discrete stack based on the diverse score, using the procedure discussed above.

The bid knowledge response system filters each of the processed discrete stack by applying at least one of a Natural Language Processing (NLP) technique and deep learning technique to create a plurality knowledge containers (KC1, KC2, KC3, . . . , KC4). The knowledge container contains filtered information with key insights.

The bid generator dynamically generates, using the filtered information with the key insights, the service proposal response for the type of service requested. The service proposal response may be in the form of BID document. In one non-limiting embodiment. The bid document may be provided to the BID portal.

FIG. 6 illustrates an embedding generation using Bidirectional Encoder Representations from Transformers (BERT), in accordance with an embodiment of the present disclosure.

In an embodiment of the present disclosure, BKRS uses the BERT training for identifying features in the data. The data from the BKRS repository is passed onto BERT for features mapping. The BERT cleans and converts the documents into sentence embeddings (multilingual support) and then into vector (O1, O2, O3, O4, O5). The documents represented as vectors are then processed. The output is a sequence of vectors. BERT uses MaskedLM (MLM) and NSP for masking the sensitive information and tuning the diverse score values. Thus, BERT provides bidirectional context learning and improves the accuracy of the result.

Thus, the BERT fine tunes results in a better contextualized form of documents which are then placed into their respective four available containers. The BERT Model gets saved and updated for classification tasks. In one non-limiting embodiment, the documents pass through BERT and thus are fine tuned for better contextualized form of documents, the tuned documents are then well classified into their respective containers.

FIG. 7 (a) illustrates a workflow for extracting text from an image using Tesseract 4, in accordance with an embodiment of the present disclosure.

In an embodiment of the present disclosure, for image processing tasks, Tesseract may be used to extract the textual information available in the image and make it available for further processing. The extracted textual information from the image may be passed onto the BERT model, which in turn classifies under which container the image must be placed by understanding the textual information.

In an embodiment of the present disclosure, application of deep learning technique may comprise applying Tesseract 4 for recognizing text in images. The Tesseract 4 is a neural network-based recognition engine which extracts text from document images. Then these feature maps are embedded into an input for the long-short term memory LSTM, as discussed in detail below.

FIG. 7 (b) shows an exemplary neural network layers for generating a service proposal response and FIG. 7(c) illustrates long-short term memory (LSTM) layers, in accordance with an embodiment of the present disclosure.

In an embodiment of the present disclosure, the data inside LSTM are represented in the form of neurons. The input neuron would transform the input data into hidden data then calculates weights and gets the context from the data. The context is then fed to another input layer which again calculates the weights based on context from previous learnings and recreates the context for the input. Thus, the inputs flow through the various channels of hidden layers as shown in FIG. 7(b).

FIG. 7(d) illustrates an exemplary long short-term memory (LSTM) approach, in accordance with an embodiment of the present disclosure.

In an embodiment of the present disclosure, the LSTM combines the new value and the data from previous node. The combined data is then fed to activation function where it decides whether the forget value should be open, closed or open to certain extent. The same combined value in parallel is also fed to the tan h operation layer where it decides what has to be passed to the memory pipeline which will become the output to the module. Thus, LSTM classifies the image to be placed in the one or more knowledge containers.

The user interface 401 may include at least one of a key input means, such as a keyboard or keypad, a touch input means, such as a touch sensor or touchpad, and the user interface may include a gesture input means. Further, the user interface 401 may include all types of input means that are currently in development or are to be developed in the future. The user interface 401 may receive information from the user through the touch panel of the display and transfer at least one processor 403.

The at least one processor 403 may comprise a memory and communication interface. The memory may be software maintained and/or organized in loadable code segments, modules, applications, programs, etc., which may be referred to herein as software modules. Each of the software modules may include instructions and data that, when installed or loaded on a processor and executed by the processor, contribute to a run-time image that controls the operation of the processors. When executed, certain instructions may cause the processor to perform functions in accordance with certain methods and processes described herein.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

Suitable processors include, by way of example, a processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

Exemplary embodiments discussed above may provide certain advantages. Though not required to practice aspects of the disclosure, these advantages may include those provided by the following features.

In an embodiment, the present disclosure provides an autonomous system that learns from the data and knowledge residing across various systems used by different business teams for coordinating, storing and collaborating to create the bid response or service proposal response.

In an embodiment, the present disclosure reduces the dependency on human intervention and human intelligence.

Reference Numbers:

| Reference | |
|---|---|
| Number | Description |
| 300 | METHOD |
| 400 | SYSTEM |
| 401 | USER INTERFACE |
| 403 | AT LEAST ONE PROCESSOR |
| 405 | MEMORY |
| 407 | DOCUMENT INTERFACE COMPUTATIONAL TASK |
| | (DICT) UNIT |
| 409 | INFORMATION CONTEXT ANALYZER (ICA) UNIT |
| 411 | BID KNOWLEDGE RESPONSE SYSTEM (BKRS) UNIT |
| 413 | BID GENERATOR UNIT |
| 415 | NEURAL NETWORK |
| 417 | MEMORY |
| 419 | ONE OR MORE PROCESSORS |

We claim:

1. A method for generating a service proposal response, the method comprising:
receiving a request for service proposal indicative of a type of service requested;
collating data from a plurality of repositories based on the type of service requested;
extracting required information from the collated data;
creating a discrete stack for the extracted information for the data collated from each of the plurality of repositories, wherein each discrete stack indicates extracted information of a particular repository in sorted format;
processing each of the discrete stack to add a context to the extracted information by computing a diverse score for each information, based on the request for service proposal;
filtering each of the processed discrete stack by applying at least one of a Natural Language Processing (NLP) technique and deep learning technique to create a knowledge container, wherein the knowledge container contains filtered information with key insights, and
dynamically generating, using the filtered information with the key insights, the service proposal response for the type of service requested.

2. The method as claimed in claim 1, further comprising:
providing to at least one user access to the generated service proposal response; and
displaying the service proposal response in a readable format on a user interface.

3. The method as claimed in claim 1, wherein processing each of the discrete stack to add the context to the extracted information comprises:
computing the diverse score for each information present in the discrete stack, wherein the diverse score is computed based on a set of parameters including information in discrete stack, a total number of same information in the discrete stack of the repository, and a total number of same information in the discrete stack of other repositories; and
rearranging each of the information in the discrete stack based on the diverse score.

4. The method as claimed in claim 1, wherein filtering each of the processed discrete stack comprises:
masking sensitive information from each of the processed discrete stack of extracted information;
applying the at least one of the NLP technique and the deep learning technique to generate key insights for unmasked information present in the processed discrete stack; and
storing the unmasked information present in the discrete stack along with the respective key insights in the knowledge container, wherein the key insight comprises tuned diverse score for each unmasked information present in the discrete stack.

5. The method as claimed in claim 1, wherein the at least one NLP technique and deep learning technique comprises Bidirectional Encoder Representations from Transformers (BERT) and Tesseract 4.

6. A system for generating a service proposal response, the system comprising:
a memory;
a user interface in communication with the memory and configured to receive a request for service proposal indicative of a type of service requested;
at least one processor in communication with the memory and the user interface;
a document interface for computational task (DICT) unit in communication with the at least one processor and configured to:
collate data from a plurality of repositories based on the type of service requested;
extract required information from the collated data; and
create a discrete stack for the extracted information for the data collated from each of the plurality of repositories, wherein each discrete stack indicates extracted information of a particular repository in sorted format;
an information context analyzer (ICA) unit in communication with the DICT unit and the at least one processor, wherein the ICA unit is configured to process each of the discrete stack to add a context to the extracted information by computing a diverse score for each information, based on the request for service proposal;
a Bid Knowledge Response System (BKRS) unit in communication with the ICA unit and the at least one processor, wherein the BKRS unit is configured to filter each of the processed discrete stack by applying at least one of a natural language processing (NLP) technique and deep learning technique to create a knowledge container, wherein the knowledge container contains filtered information with key insights; and
a bid generator unit in communication with the BKRS unit and the at least one processor, wherein the bid generator unit is configured to dynamically generate, using the filtered information with the key insights, the service proposal response for the type of service requested.

7. The system as claimed in claim 6, wherein the at least one processor is configured to:
provide to at least one user access to the generated service proposal response;
wherein the user interface is configured to display the service proposal response to the at least one user.

8. The system as claimed in claim 6, wherein to process each of the discrete stack to add the context to the extracted information, the ICA unit is configured to:
compute the diverse score for each information present in the discrete stack, wherein the diverse score is computed based on a set of parameters including information in discrete stack, a total number of same information in the discrete stack of the repository, and a total number of same information in the discrete stack of other repositories; and
rearrange each of the information in the discrete stack based on the diverse score.

9. The system as claimed in claim 6, wherein to filter each of the processed discrete stack, the BKRS unit is configured to:
mask sensitive information from each of the processed discrete stack of extracted information;
apply the at least one of the NLP technique and the deep learning technique to generate key insights for unmasked information present in the stack; and
store the unmasked information present in the stack along with the respective key insights in the knowledge container, wherein the key insight comprises tuned diverse score for each unmasked information present in the discrete stack.

10. The system as claimed in claim 6, wherein the at least one NLP technique and deep learning technique comprises Bidirectional Encoder Representations from Transformers (BERT) and Tesseract 4.
